(19) United States
(12) Patent Application Publication
(10) Pub. No.: US 2017/0154096 A1
(43) Pub. Date: Jun. 1, 2017

(54) DATA SERVICE SYSTEM AND ELECTRONIC APPARATUS

(71) Applicants: LE HOLDINGS (BEIJING) CO., LTD., Beijing (CN); LE SHI INTERNET INFORMATION & TECHNOLOGY CORP., BEIJING, Beijing (CN)

(72) Inventor: Lei QIAO, Beijing (CN)

(73) Assignees: LE HOLDINGS (BEIJING) CO., LTD., Beijing (CN); LE SHI INTERNET INFORMATION & TECHNOLOGY CORP., BEIJING, Beijing (CN)

(21) Appl. No.: 15/243,231

(22) Filed: Aug. 22, 2016

Related U.S. Application Data
(63) Continuation of application No. PCT/CN2016/089514, filed on Jul. 10, 2016.

(30) Foreign Application Priority Data
Dec. 1, 2015 (CN) 2015108614097

(51) Int. Cl. G06F 17/30

(52) U.S. Cl. CPC G06F 17/30598

(57) ABSTRACT

An embodiment of the present disclosure relates to the field of information technologies, and discloses a data service system and an electronic apparatus, where the system includes: a content management system (CMS); a third-party capturing database configured to store data captured by a third party; a data processing library configured to divide the data into key data and non-key data, store the non-key data into the content management system, and input the key data into an application management system; and the application management system (AMS) configured to examine the key data, and store the key data passing the examination into the content management system. By the foregoing technical solution, data from the third-party captured database may be classified and examined. On one hand, efficiency of data processing is increased by means of classification, and on the other hand, effectiveness of the data stored into the content management system is ensured, so that a user can trustingly acquire data in the content management system, thereby improving user experience.

### CROSS-REFERENCE TO RELATED APPLICATIONS

This application is a continuation of International Application No. PCT/CN2016/089514, with an international filing date of Jul. 10, 2016, which is based upon and claims priority to Chinese Patent Application No. 201510861409.7, filed on Dec. 1, 2015, the entire contents of all of which are incorporated herein by reference.

### TECHNICAL FIELD

The present disclosure relates to the field of information technologies, and in particular, to a data service system and an electronic apparatus.

### BACKGROUND

With rapid development of networks, the Internet becomes a carrier for massive information, and how to effectively extract and utilize these information becomes a great challenge. Search engines (for example, traditional general search engines Baidu, Yahoo, and Google, etc.), as a tool assisting people to retrieve information, become an entry and guide for users to access the World Wide Web. However, these general search engines also have some limitations: for example, (1) users from different fields and different backgrounds usually have different retrieval purposes and needs, and results returned by a general search engine include numerous web pages in which the users are not interested; (2) an objective of general search engines is greatest possible network coverage, and conflicts between limited search engine server resources and limitless network data resources will further deepen; (3) with the richness of data forms of the World Wide Web and the continuous development of network technologies, there appear massive different data such as pictures, databases, audio, and video multimedia, etc., and general search engines are usually incompetent at and unable to desirably discover and acquire these data having dense information contents and certain structures; and (4) general search engines mostly provide keyword based retrievals, and hardly can support inquiries made according to semantic information.

To overcome the foregoing shortcomings of search engines, crawler tools emerge, which can automatically fetch World Wide Web information according to a certain rule. However, data captured by crawler tools are so miscellaneous that for an operator some data may not be directly provided for a user to use. How to effectively manage such data becomes a problem urgently needed to be solved.

### SUMMARY

An objective of some embodiments of the present disclosure is to provide a data service system, where the data service system can effectively manage data from a third party fetch tool (for example, a crawler tool) so that the data can be safely and reliably provided for a user to use.

To implement the foregoing objective, an embodiment of the present disclosure provides a data service system, where the system includes: a content management system (CMS); a third-party capturing database configured to store data captured by a third party; a data processing library configured to divide the data into key data and non-key data and store the non-key data into the content management system and input the key data into an application management system; and the application management system (AMS) configured to examine the key data and store the key data passing the examination into the content management system.

The data processing library may divide the data into key data and non-key data according to one or more of the following of an application to which the data belong: daily downloads, daily installations, weekly downloads, weekly installations, monthly downloads, and monthly installations.

The application management system may perform one or more of the following examinations on the key data: an install and uninstall examination, an operation stability examination, a function traversal examination, and a performance examination.

The system may further include a cloud examination system configured to perform antivirus and terminal adaptation examinations on the data in the application management system and the content management system.

The system may further include a developer platform, where data from the developer platform is directly stored into the content management system.

The application management system may further be configured to perform an examination on the data on the developer platform, and store data passing the examination into the content management system.

The content management system may generate, for the stored data, an incremental file for an application to which the data belong.

All data input into the data processing library from the third-party captured database may be incremental data.

According to an embodiment of the present disclosure, there is provided with a non-transitory computer-readable storage medium storing executable instructions that, when executed by an electronic apparatus, cause the electronic apparatus to: divide the data captured by a third-party capturing database into key data and non-key data; store the non-key data into a content management system; input the key data into an application management system; and examine the key data and store the key data passing the examination into the content management system.

According to an embodiment of the present disclosure, there is provided with an electronic apparatus. The electronic apparatus includes: at least one processor; and a memory communicably connected with the at least one processor for storing instructions executable by the at least one processor, wherein execution of the instructions by the at least one processor causes the at least one processor to: divide the data captured by a third-party capturing database into key data and non-key data; store the non-key data into a content management system; input the key data into an application management system; and examine the key data and store the key data passing the examination into the content management system.

By the foregoing technical solution, data from the third-party captured database may be classified and examined. On one hand, efficiency of data processing is increased by means of classification, and on the other hand, effectiveness of the data stored into the content management system is ensured, so that a user can trustingly acquire data in the content management system, thereby improving user experience.

Other features and advantages of the present disclosure are described in detail in the detailed description section below.

### BRIEF DESCRIPTION OF THE DRAWINGS

The accompanying drawings are intended to provide a further understanding of some embodiments of the present disclosure, and constitute a part of this specification. The drawings are intended to be used in combination with specific implementation manners below to understand the present disclosure, but not to limit the present disclosure. In the accompanying drawing:

FIG. 1 is structural block diagram of a data service system according to an embodiment of the present disclosure.

FIG. 2 is a schematic hardware diagram of an electronic apparatus for performing a data service system according to some embodiments of the present disclosure.

List of Reference Numerals:

| | |
|---|---|
| 100 Content management system | 200 Third-party capturing database |
| 300 Data processing library | 400 Application management system |
| 500 Developer platform | 600 Cloud examination system |

### DETAILED DESCRIPTION

Specific implementation manners of some embodiments of the present disclosure are described in detail below with reference to the accompanying drawings. It is to be understood that the specific implementation manners described herein are intended only to describe and explain the present disclosure, but not to limit the present disclosure.

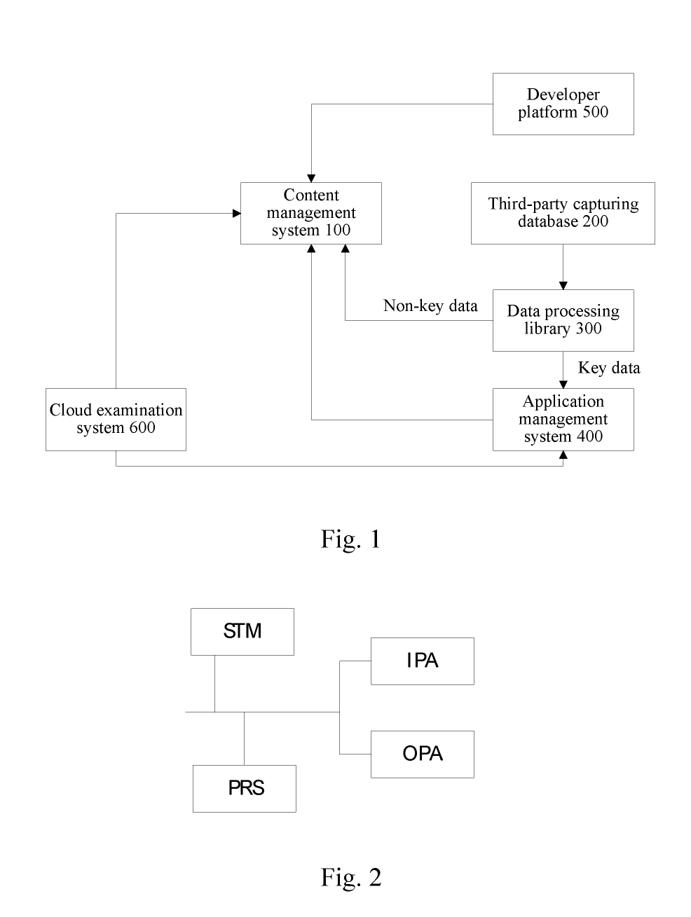

FIG. 1 is a structural block diagram of a data service system according to an embodiment of the present disclosure. As shown in FIG. 1, an embodiment of the present disclosure provides a data service system, where the system includes: a content management system 100, which is a software system located between a Web server and a back-end office system or flow (content creation and editing), and the contents stored therein are contents (for example, applications, files, tables, pictures, data in databases, and even videos, etc.) that are submitted, modified, examined and approved, and published by creators, editors, and publishers, so that a user can download needed data from the content management system 100; a third-party capturing database 200 configured to store data captured by a third party, where the data captured by the third party may include various types of data of interest captured from networks by using a crawler tool; a data processing library 300 configured to divide the data into key data and non-key data and store the non-key data into the content management system, and input the key data into an application management system; and the application management system 400 configured to examine the key data, and store the key data passing the examination into the content management system.

The system may further include a developer platform 500, where data from the developer platform 500 may be directly stored into the content management system 100. Generally, the developer platform 500 is a platform on which internal personnel of an operator carry out software development according to uniform standards. Data published by the developer platform 500 usually have higher reliabilities than those of data from the third-party captured database 200, and therefore can be directly stored into the content management system 100 for users to use. Certainly, the application management system 100 may also perform an examination on the data on the developer platform 500, and store the data passing the examination into the content management system, which can further ensure data reliability. Different application management systems may be respectively set for the developer platform 500 and the key data from the data processing library 300 for examination.

The data processing library 500 may divide the data into key data and non-key data according to one or more of the following of an application to which the data belong: daily downloads, daily installations, weekly downloads, weekly installations, monthly downloads, and monthly installations. For example, an application whose daily downloads exceed 10,000 may be set as a key application, and an application whose daily downloads are below 5,000 may be set as a non-key application, and data respectively belonging to the key application and the non-key application are respectively key data and non-key data. For non-key data, because it affects a narrow range of population, the non-key data may be directly stored into the content management system without examination. For key data, it needs to be examined by the application management system 400 and afterwards stored into the content management system 100.

Data from the third-party captured database 200 can be divided into three types of data: incremental data, key data, and non-key data. The key data and the non-key data constitute all data in the third-party captured database 200, and the incremental data are supplemental to the key data and the non-key data. Generally, for the data processing library 300, incremental data from the third-party captured database 200 are processed once every five minutes, and key data are processed twice every hour, and non-key data are checked once every two days. For the key data and the non-key data, processing by the data processing library 300 is only checking on corresponding incremental data.

The application management system 400 may perform one or more of the following examinations on the key data and other data needed to be examined (for example, data failing examination previously): an install and uninstall examination (which is specifically testing whether an application can be normally installed and normally uninstalled on specified 100 batch terminals), an operation stability examination (which is specifically testing stability when an application is actually running, and recording errors and alarms during the operation), a function traversal examination (which is specifically automatically identifying functions that can be executed by an application, traversing all functions of the application as far as possible within a time period, recording an operation path by screenshots, and recording a log and crash event), and a performance examination (which is specifically testing performance data when an application is running on a specified terminal, including a start time, CPU consumption, memory consumption, and the like, so as to provide references for performance optimization of the application). Certainly, the present disclosure is not limited thereto, and other needed examinations can also be applied herein. For example, it can be determined whether an application includes national policy sensitive contents etc., by means of some manual examinations.

To further ensure reliability of data in the content management system 100, the data service system in the present disclosure may further include: a cloud examination system 600 configured to perform antivirus and terminal adaptation examinations (which is specifically testing and recording, based on a real terminal device (for example, a model of mobile phone of Letv Co. Ltd.) whether an actual displayed interface of an application matches a screen of the target real terminal, and the like) on the data in the application management system 400 and the content management system 100.

After the foregoing processing, the content management system 100 may have all data, and may generate incremental files for all the data. For example, for an application, an incremental package or an update installation package for Android between different versions of the application, so that download of unnecessary files can be reduced when a user updates the application (for example, updating by an entire file package needs download traffic of 50 MB, while when an incremental file exists, update can be completed by downloading only a file of 10 MB).

By the foregoing technical solution, data from the third-party captured database may be classified and examined. On one hand, efficiency of data processing is increased by means of classification, and on the other hand, effectiveness of the data stored into the content management system is ensured, so that a user can trustingly acquire data in the content management system, thereby improving user experience.

According to an embodiment of the present disclosure, there is provided with a non-transitory computer-readable storage medium storing executable instructions that, when executed by an electronic apparatus, cause the electronic apparatus to perform any one of above disclosed data service system.

FIG. 2 illustrates a schematic hardware diagram of an electronic apparatus for performing any one of above disclosed data service system. According to FIG. 2, the electronic apparatus includes one or more processors PRS and a storage medium STM. FIG. 2 shows one processor PRS as an example.

The electronic apparatus can further include an input apparatus IPA and an output apparatus OPA.

The one or more processors PRS, storage medium STM and output apparatus OPA may be connected by a bus or other means. FIG. 2 shows a bus as an example for connection.

Storage medium STM is a non-transitory computer-readable medium for storing a non-transitory software program, a non-transitory computer-readable program and module, for example the program instructions/module for performing an above described data service system (e.g. content management system 100, data processing library 300, application management system 400 and cloud examination system 600 shown in FIG. 1). The processor PRS can operate the various functions and data processing of a server to perform a method described in the above embodiments by executing non-transitory software programs, instructions and modules stored in the storage medium STM.

The storage medium STM can include a program storage area and a data storage area. Among them, the program storage area may store operation system, application programs of at least one function; the data storage area may store generated data during operation of the electronic apparatus for performing the method described in the above embodiments. In addition, the storage medium STM may include a high speed random access memory, and a non-transitory storage medium, for example a magnetic storage device (e.g., hard disk, floppy disk, and magnetic strip), a flash memory device (e.g., card, stick, key drive) or other non-transitory solid state storage device. In some embodiments, the storage medium STM may include a storage medium that is remote to the processor PRS. The remote storage medium may be connected to the electronic apparatus for performing any of the above methods by a network. The examples of such as network include but not limited to Internet, enterprise intranet, local area network, mobile telecommunication network and a combination thereof.

The input apparatus IPA can receive input number or byte information, and can generate input key information relating to user setting and functional control of the electronic apparatus for performing the method described in the above embodiments. The output apparatus OPA may include a display device such as a display screen.

The one or more modules stored in the storage medium STM that, when executed by the one or more processors PRS, can perform any of the above described methods.

The above products can perform any of the above described methods, and have corresponding functional modules and effects. Details that are not disclosed in this embodiment can be understood by reference to the above method embodiments of the present disclosure.

An electronic apparatus of the present disclosure can exist in a varied form and includes but not limited to:
(1) A mobile communication device which is capable of performing mobile communication function and having a main purpose for audio or data communication. Such a mobile communication device includes: a smart phone (e.g. iPhone), a multimedia phone, a functional mobile phone and a low-end mobile phone etc.
(2) A super-mobile personal computer which belongs to the field of a personal computer and has calculation and processing functions, and in general can access to a mobile network. Such a terminal device includes: a PDA, a MID and a UMPC etc., for example iPad.
(3) A portable entertainment device which is capable of displaying and playing multimedia content. Such a device includes: an audio player, a video player (e.g. iPod), a handheld game console, an electronic book, a smart toy and a portable automotive navigation device.
(4) A server which can provide calculation service and can include a processor, a hard disk, a memory, a system bus etc. Such a server is similar to a general computer in terms of a computer structure, but is necessary to provide reliable service, which therefore requires a higher standard in certain aspects such as data processing, stability, reliability, security and compatibility and manageability etc.
(5) Other electronic apparatus that is capable of data exchange.

The above described apparatus embodiments are for illustration purpose only, in which modules/units that are described above as separate elements may be physically separate or not separate and modules/units that are described above as display elements may be or may not be a physical unit, i.e. in a same location or in various distributed network units. The skilled person in this field can understand that it is possible to select some or all of the units or modules to achieve the purpose of the embodiment.

According to the above description, the skilled person in this field can understand that various embodiments can be implemented by software over a general hardware platform or by hardware. Accordingly, the above technical solution or what is contributed to the prior art may be implemented in the form of software product. The computer software product may be stored in a computer-readable storage medium, for example random access memory (RAM), read only memory (ROM), compact disk (CD), digital versatile disk (DVD) etc. which includes instructions for causing a computing device (e.g. a personal computer, a server or a network device etc.) to perform a method of some or all parts of any one of the above described embodiments.

Preferred implementation manners of some embodiments of the present disclosure are described above with reference to the accompanying drawings. However, the present disclosure is not limited by specific details in the foregoing implementation manners. Multiple simple variations may be made to the technical solutions in the present disclosure within the scope of the technical concept of the present disclosure, and these simple variations all fall within the protection scope of the present disclosure.

In addition, it is to be noted that, the specific technical features described in the foregoing specific implementation manners may be combined in any appropriate manner without conflicts. To avoid unnecessary repetitions, in the present disclosure, various possible combination manners are not described herein additionally.

Moreover, various different implementation manners of the present disclosure may also be combined in any manner, which should also be considered to be contents disclosed by the present disclosure without departing from the spirit of the present disclosure.

What is claimed is:

1. A data service system, comprising:
a content management system;
a third-party capturing database configured to store data captured by a third party;
a data processing library configured to divide the data into key data and non-key data, store the non-key data into the content management system, and input the key data into an application management system; and
the application management system configured to examine the key data, and store the key data passing the examination into the content management system.

2. The data service system according to claim 1, wherein the data processing library divides the data into key data and non-key data according to one or more of the following of an application to which the data belong: daily downloads, daily installations, weekly downloads, weekly installations, monthly downloads, and monthly installations.

3. The data service system according to claim 1, wherein the application management system performs one or more of the following examinations on the key data: an install and uninstall examination, an operation stability examination, a function traversal examination, and a performance examination.

4. The data service system according to claim 1, wherein the system further comprises:
a cloud examination system configured to perform antivirus and terminal adaptation examinations on the data in the application management system and the content management system.

5. The data service system according to claim 1, further comprising:
a developer platform, wherein data from the developer platform is directly stored into the content management system.

6. The data service system according to claim 5, wherein the application management system is further configured to perform an examination on the data on the developer platform, and store the data passing the examination into the content management system.

7. The data service system according to claim 1, wherein the content management system generates, for the stored data, an incremental file for an application to which the data belong.

8. The data service system according to claim 1, wherein all data input from the third-party captured database are incremental data.

9. A non-transitory computer-readable storage medium storing executable instructions that, when executed by an electronic apparatus, cause the electronic apparatus to:
divide the data captured by a third-party capturing database into key data and non-key data;
store the non-key data into a content management system;
input the key data into an application management system; and
examine the key data and store the key data passing the examination into the content management system.

10. The storage medium according to claim 9, wherein the storage medium comprises further instructions to:
divide the data into key data and non-key data according to one or more of the following of an application to which the data belong: daily downloads, daily installations, weekly downloads, weekly installations, monthly downloads, and monthly installations.

11. The storage medium according to claim 9, wherein the storage medium comprises further instructions to:
perform one or more of the following examinations on the key data: an install and uninstall examination, an operation stability examination, a function traversal examination, and a performance examination.

12. The storage medium according to claim 9, wherein the storage medium comprises further instructions to:
perform antivirus and terminal adaptation examinations on the data in the application management system and the content management system.

13. The storage medium according to claim 9, wherein the storage medium comprises further instructions to directly store data from a developer platform into the content management system.

14. The storage medium according to claim 13, wherein the storage medium comprises further instructions to perform an examination on the data on the developer platform, and store the data passing the examination into the content management system.

15. The storage medium according to claim 9, wherein the storage medium comprises further instructions to generate, for the stored data, an incremental file for an application to which the data belong.

16. The storage medium according to claim 9, wherein all data input from the third-party captured database are incremental data.

17. An electronic apparatus, comprising:
at least one processor; and a memory communicably connected with the at least one processor for storing instructions executable by the at least one processor;
wherein execution of the instructions by the at least one processor causes the at least one processor to:
divide the data captured by a third-party capturing database into key data and non-key data;
store the non-key data into a content management system;
input the key data into an application management system; and
examine the key data and store the key data passing the examination into the content management system.

18. The electronic apparatus according to claim 17, wherein the memory comprises further instructions to:
divide the data into key data and non-key data according to one or more of the following of an application to which the data belong: daily downloads, daily installations, weekly downloads, weekly installations, monthly downloads, and monthly installations.

19. The electronic apparatus according to claim 17, wherein the memory comprises further instructions to:
perform one or more of the following examinations on the key data: an install and uninstall examination, an operation stability examination, a function traversal examination, and a performance examination.

20. The electronic apparatus according to claim 17, wherein the memory comprises further instructions to:
perform antivirus and terminal adaptation examinations on the data in the application management system and the content management system.
